(19) United States
(12) Patent Application Publication
(10) Pub. No.: US 2011/0060650 A1
(43) Pub. Date: Mar. 10, 2011

(54) METHOD OF FACILITATING THE VENDOR ADVERTISEMENT TO LOCAL CONSUMERS VIA DECENTRALIZED SELF-ADJUSTABLE INTERNET BASED APPARATUS

(75) Inventors: Yefim Maranets, Brooklyn, NY (US); Boris Maranets, Milford, CT (US)

(73) Assignee: Yefim Maranets, BROOKLYN, NY (US)

(21) Appl. No.: 12/556,568

(22) Filed: Sep. 9, 2009

(51) Int. Cl. G06Q 30/00; G06Q 50/00; G06F 15/16

(52) U.S. Cl. 705/14.54; 707/E17.044; 707/E17.018; 707/E17.017

(57) ABSTRACT

Proposed are a method and apparatus to improve the food market advertisement in a geo-spatial environment. The goal is achieved by a uniform inventory presentation of the local food store on a common Internet site. That in turn motivates the vendors to participate in a disclosed service, and attracts the customers by a competitive pricing layout. An embodiment determines “on-the-fly” some local gourmet preferences to facilitate the regional and ethnic food market advertisement. The goal is achieved by extracting the evocative product features from the food descriptions provisioned by vendors. Anticipating a massive network load, the proposal also includes an algorithm of allocating a distributed structure to optimize the system's load balance.

### FIELD OF THE INVENTION

The present invention relates to an Internet-based advertising strategy that addresses consumer selectivity of the best product in a competitive regional food market.

### BACKGROUND OF THE INVENTION

A field of the gourmet advertisement is characterized on the one hand by a vendor's desire to publish the inventory with the best product presentational features, and on the other hand by satisfying a consumer's (hereinafter also referred to as “buyer” and “user”) expectations of finding a bargain across a vast variety offered in the market. Emergence of the worldwide Internet and mobile telecommunication industry brought around a technology that made it possible to address the needs of both parties.

For example, sellers' directory in the “Yellow Pages” (www.yellowpages.com) finds a group of food stores local to the entered address, but falls short of informing the user on the vendor's inventory and up-to-date price list. Therefore, the “Yellow Pages” fails to provide the current availability of a searched product nearby and the location of the bargain price.

Conversely, Costco Superstore (www.costco.com), on the other hand, displays its affiliated locations and food product inventory along with pricing information. Similarly, www.freshdirect.com presents inventory from only one vendor—“Fresh Direct.” The shortcoming of those approaches, however, is that the customer has no means to compare their inventory against that of other competitors in the market and is thus required to perform a series of extraneous navigational steps on the Web. A pronounced inconsistency between layouts of Costco and other vendors prevents consumers from easily comparing products across the stores and therefore obtaining a uniform perception of the best attainable bargain.

Multiple publications are dedicated to dynamic forecasts of a rational market price by executing sophisticated analytical procedures. These publications differ among themselves by slight modifications in the algorithm tactics. Some of them, like those disclosed in the U.S. Pat. No. 6,625,581 to Perkowski, and patent application Ser. Nos. 12,149,663 to Woolston, 12,273,227 to Peshkam, may incorporate a search engine to collect and present links to product information, extracted from different sources on the Web. They redirect the viewer to pre-collected Internet pages by employing the HTML hyperlinks and require the user to jump across different Web pages to obtain the necessary information. A significant disadvantage of this method is a necessity for numerous navigational steps over the multiple gathered sources characterized by various formats. In addition, the authors acknowledge that the solution they propose comes with an increase in the number of network hits.

A Korean Application 1,020,000,054,887 to Yu Seok Ho proposed an Internet system, where a middleman watch operator manages the advertisement process. This approach is inapplicable across the numerous regional markets.

An attempt to determine and locate the best price is found in a financial art—the U.S. patent application Ser. No. 11,960,922 to Kidder. It focuses the consumer attention on the Internet advertisements by rendering results of the statistical metrics analysis across plurality of marketing networks. It attempts to make a significant advertisement impact by analyzing a limited set of sources. The proposed approach fails to adjust for an arbitrary situation across the plural regions as the parameters of the analysis need to be specifically pre-configured for each of the known cases.

A similar disadvantage is adherent to a group of U.S. patent applications, among those are the Ser. No. 12,131,209 to Dube and Ser. No. 12,217,095 of Musgrove. They illustrate the method, computer program, and apparatus for real-time price planning for on-demand e-commerce market competition. The first art organizes an intelligent Web crawler, and applies some theoretical patterns to the obtained results. The second compares the real market prices to the fair values derived by the estimation. Downside of the above mentioned art is that the price approximation trend predicted by computation differs from what the market settles for in real competition. Also, it lacks the self-adjustment towards evolving regional needs and real market price fluctuation.

A need to account the user group preference based on the specific region is described in the following art—the U.S. patent application Ser. No. 11,827,401 to Abhyanker. It offered a method of organizing a community network based on the location of the user in the world. Although this system improved the network performance, it was applicable exclusively to the computer hardware optimization, making it irrelevant for the gourmet market ads.

Some prior art employed the advantages of the mobile telecommunication technology to locate geographic position of a consumer in order to route the advertisements of the regional commerce to him or her. A sample of this is the U.S. patent application Ser. No. 11,537,512 to Walton. It recommends tracing or identifying the mobile device location and having that redirected to the central processing server for product ordering, pick up, and price notification. The intention of this art is to send the vendor's ads to a potential customer arriving into the area. One drawback of the said system is its centralized organization and another clear disadvantage—it lacks a uniformed comparison of the products across vendors' plurality in the local market.

### SUMMARY OF THE INVENTION

A genuine desire of the consumers is to purchase food products which meet the characteristics of their interests. Moreover, they desire to procure these products at a bargain price and at a proximal location. Also, the vendors everywhere prefer a service that advertises their inventory on timely basis and attracts buyers according to certain product characteristics that are desired in the vicinity and are applicable to the local ethnic group.

The usage of a sophisticated mathematical model used for price forecasting is limited in its application and insufficient for needs of an arbitrary regional market, which constantly evolves. Proliferated spawn of gourmet pricing forecasting tools indicates a need for a common solution, which is flexible enough to work across a variety of settings and characteristics. The proposed embodiment will possess a single Internet address, which will be accessible by a multitude of locations globally. Therefore, the proposed invention finds a solution that can address any local market challenges, while naturally accommodating a distributed implementation of server hosting and data storage at the same time.

A proposed embodiment utilizes the same technology and component means as outlined in the U.S. patent application Ser. No. 11,537,512, and adheres to approach of grouping products into categories, as referred in the earlier discussed arts. With that said, this invention operates without a predetermined price estimation model. It allows the vendors and customers to interact with the proposed system via widely available Internet and other mediums, such as, but not limited to, mobile telecommunication devices, and SMS text messaging.

The present invention eliminates a middleman, either as a central decision maker, or as an expert, monitoring the plural regional markets. With this regard, it effectively becomes de-centralized and self-adjusted. Organized in a form of a search engine, the present invention implicitly serves a marketing role by extracting the “buzz word” product characteristics and automatically forwarding them to customers without any manual labor. Our proposal seamlessly applies to any region with a known local language having an established computerized form of a word dictionary.

Some of the preferred embodiments of this invention may tag the product attributes, formulating the regional food preferences, and run-time binding of these preferences to the relevant geographic and ethnic areas. This capability becomes an important premise for the proposed global, Internet-based advertisement network. It is important to highlight a fact that detailed product features are unknown to the system ahead of time and their relevance to a specific region may be determined during process of execution of customer requests. For instance, the rotten fish flavor is considered delicious in some regions, while taste possibly even repulsive, somewhere else. See Joe Cummings, Lonely Planet: World Food: Thailand, p. 158 (2000).

Having one Internet address announced to the public, the proposed embodiment may undergo a network hit increase ramification, caused by the growing of a consumer community demands. As a secondary advantage, the present invention accommodates the problem of hardware load balancing. Encapsulating the data and work flow within regions where the requests originated from, the embodiment allocates the plural system partitions close to consumer communities.

Sharing a collective Web site by plural vendors, the present invention guarantees the lowest vendor subscription fee and serves the community needs. Another advantage of the proposed invention is uniformed presentation of the multiple vendor inventories on the same HTML page. It gives more lucrative options for customers and raises the competitiveness. An arbitrary combination of prior art is unable to procreate the results achieved by this invention. That is because the proposed advertisement process is enhanced with the disclosed means for self-adjustment, ensuring autonomous operation without the central interfering for any unspecified location.

The proposal is intended to operate seamlessly over the plural national languages. That is guaranteed by computerized dictionary means, correcting the inserted information according to an individual spelling standard. Additionally, consumers understand the products description, provisioned by a local vendor, and are able to search features using their native alphabet key set.

Achievements of the present invention will become apparent from the following description of an embodiment thereof, illustrated by the accompanying drawings. It is to be understood that the following detailed description is exemplary only and not restrictive to the invention as claimed.

### BRIEF DESCRIPTION OF THE DRAWINGS

The above mentioned and other advantages of the proposal will become more apparent from the following description taken in conjunction with the accompanying drawings, in which:

FIG. 1 shows a schematic overview of the present invention with distributed embodiment, projected on a regional food market.

FIG. 2 is a template form for the vendor to add a new product.

FIG. 3 is a sample customer view to specify the search criterion.

FIG. 4 describes a work flow of the Feature Extractor.

FIG. 5 illustrates a closed loop advertisement process, enhanced by the means of the proposed evocative features.

### DETAILED DESCRIPTION OF THE INVENTION

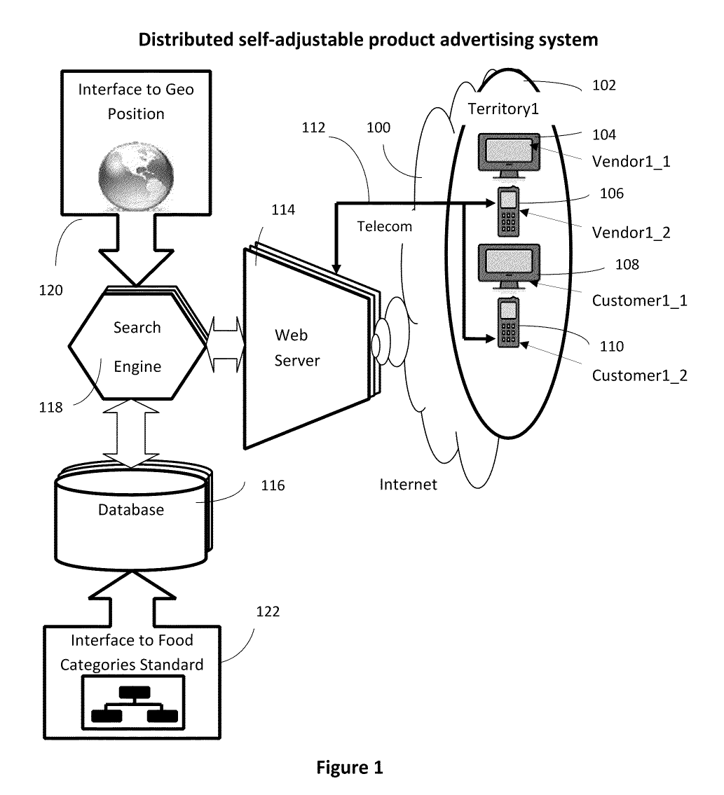

FIG. 1 presents a high level overview of the embodiment. It includes the Internet network, labeled as 100, projected to a regional market. An exemplary Territory1 out of the plural territories is referred by a numeral 102. Generically, the participants of the market may be presented as Vendor1_1 and Vendor1_2, who may upload and modify their inventory by a computer or a wireless communication device. Those vendors are labeled 104 and 106, respectively. The buyers at Territory1 are shown as Customer1_1 and Customer1_2, labeled 108 and 110, respectively. First, they may communicate with the said advertising system by a computer, and second, by a mobile unit. A telecommunication system 112 connects the wireless network to an application server 114.

The preferred embodiment may include a Web Server, combined in the FIG. 1 with an application server shown by the numeral 114. Also the apparatus may include a Database 116 and a Search Engine 118 implemented having the plural partitions distributed over territories. An Interface to Geo Position 120 is to determine the latitude and longitude of the participating vendor and a customer by their given addresses. That location information is delivered to a Search Engine 118 on query processing. Also, embodiment includes an Interface to a Food Categories Standard 122. As a exemplary instance that may be a GSFA CODEX food categories document posted on the Web site

http://www.codexalimentarius.net/gsfaonline/foods/index.html

An embodiment may also include means to convert the published food product classification into a hierarchical data model and store it into the Categories Table of Database 116.

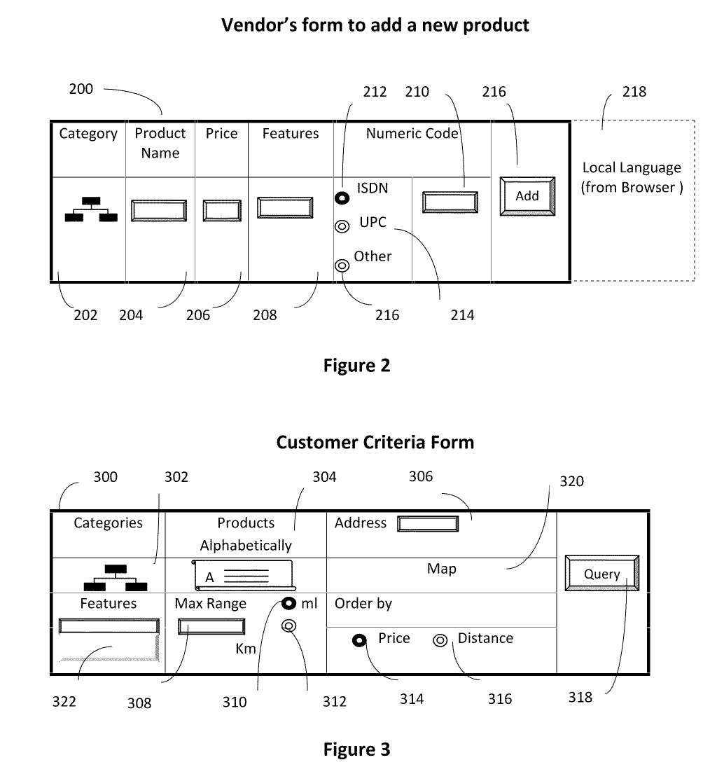

The FIG. 2 may be a schematic illustration of the form, labeled as 200, to provision store inventory into the proposed embodiment with great ease. The exemplary procedure of inserting a new product by a subscribed participant for the proposed service may include the following steps. A vendor selects a category from a Tree control 202, populated from a standard food classification by the interface 122. Typing a product name into the text field 204 a vendor associates the product with the corresponding category. Also, vendor may specify a product price in the field 206, features in the field 208, a numeric classification code in the field 210, and specify the type of numeric code used (such as UPC, ISDN or others) by clicking the radio buttons 212, 214, 216.

Pressing the “Add” button 216, vendor inserts one record into the Database. Similarly, user submits to the Database other items in his inventory. To make this process easier and more productive the system may include a user ability to upload over the server a text file containing any number of conventionally formatted records, describing the product plurality. To update some items, a vendor may first invoke a “select” query upon some product criterion to visualize the current values, and then, modify the fields, and save the updated records to the Database accordingly. An update process also implies visualization, modification and update of the whole product inventory.

FIG. 2 also includes a parameter 218 representing the user's native language. That variable may be used internally by the process, and it is not a part of the user screen. An abbreviation code of the native language may be obtained on the server side from a browser request. Normally, the user specifies and sets up his/her language selection at the browser initiation time.

To recognize the product's description in a proper spelling format, the system uses a multi-lingual dictionary. Accordingly, where users misspell a certain product's name, the system's effective recognition process will correct the spelling and propose various products with similar spelling. For instance, if the user types “aple” as the product name, implying to have said “apple,” the system guarantees that such misspelled input will be converted into a proper spelling format in compliance with the national language standard.

Current proposal may treat the product description text, provided by vendors, as a sequence of the word segments, embracing some significance for the buyers' features within. An exemplary preferred embodiment may use a separator (such as, but not limited to, a comma or a semicolon) to delineate features listed in sequence.

A simplified example of the Customer Criteria Form 300 is shown in FIG. 3. It may represent the controls by which a user specifies the search parameters:
1) “Categories” 302—implemented as a graphical tree component;
2) “Products Alphabetically” 304—arranges product list alphabetically;
3) “Address” 306—specifies user's address;
4) “Max Range” 308—gives a distance option either in miles “ml” 310 or kilometers “km” 312;
5) Order by “Price” 314 or by “Distance” 316 radio buttons.
6)“Query” button 318—initiates the search query.
7) Furthermore, FIG. 3 may also include a map, depicted by control 320, identifying the geographical position of the buyer or the store.

One of the main goals of the invention is to improve advertisement of the local food market. Promotion of the products may be done via graphics, including, but not limited to animation, icons, and video. “Features” control 322 in FIG. 3 has an illustrative appearance as it presents a simplified version of the product advertisement in the form of a drop-down list of recommended “buzz-words”. It may be compiled for the individual classification of a category or product when the user chooses control 302 or 304.

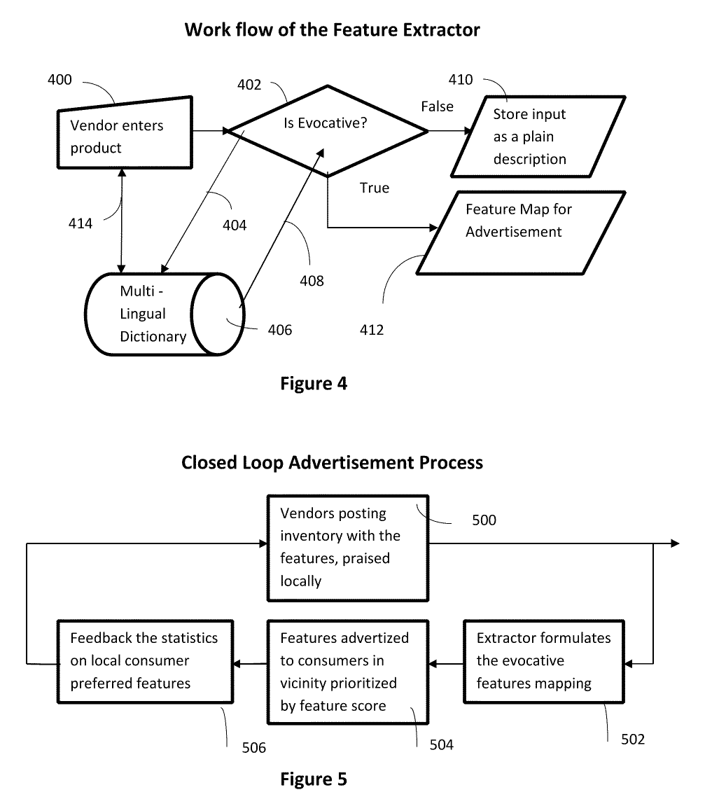

The present invention discloses a method of tagging the feature constituent words as either “Plain” or “Evocative,” what is illustrated by FIG. 4. Those characteristics indicate whether a segment of the product description may be qualified as a sizzling market “buzz-word” or as an ordinary word. When the system is processing a vendor's product description text (step 400 in the FIG. 4), the “Is Evocative?” module 402 takes a word for analysis. Specifically it sends an inquiry 404 to a partition of the multi-lingual dictionary 406, corresponding to a local language. An example of the type of word that may be deemed “evocative” is the word “rotten” as used to describe a product in That cuisine. Consequently, such call invokes an analysis of determining whether a certain word carries a descriptive function of the language. Thus, if a word in the local dictionary is identified as an adjective, adverb, or a similar part of the speech, module 406 returns a “True” as a response 408.

In case the mentioned qualification analysis returns “False,” the feature is placed in a class, referred to as a “Plain” description 410 to use exclusively for the literal search only. Otherwise, the word and the constituent of the product description feature are considered as “Evocative.” This type of word or feature may be a subject of the regular literal query similar to “Plain” description. In addition, the evocative feature can be placed in a Feature Map 412 for usage in the local advertisement process. As an auxiliary explanation, action 414 is depicted to represent the implication of a dictionary 406 for enforcing the correct spelling on the step of inventory input (step 400).

The present invention is intended to facilitate advertisement on any local product market without a central middleman. Therefore, the proposal discloses a criterion of prioritizing the features, based on the “buzz-word” statistics across the inventory description. For instance, a product may have some number of features. Hereinafter, that number will be referred to as “M” and the plurality of M features can be coded as Fᵢ (iε1, M). The symbol “ε” means “belongs to.” Expression (iε1, M) states that index “i” varies from 1 to M.

Alternatively, a plurality of the “Evocative” words can be characterized by number “N,” which represents quantity of the unique words represented as EWⱼ (jε1, N), whereas some of them may be shared between features Fᵢ. The disclosed method implies those words being preliminary converted to a generic format unifying grammar spelling across the variety of forms like plurals, tense, etc in a local language. Expression EWⱼ (jε1, N) represents N “Evocative” words EW₁, . . . , EW_{N}, where number N stands for quantity of those instances.

For each evocative word EWⱼ the proposed method calculates a number CNTⱼ equal to count of the individual “buzz-word” EWⱼ occurrences in all the features for a given product in the locality, derived on a search initiated by buyer. If a feature Fᵢ has a plurality of “Evocative” words the proposed method picks the very one word, having a highest score CNTₘₐₓ amongst others belonging to feature. That word count is assigned to a feature Fᵢ score:

Fᵢ_{_{—}}SCORE=MAX(CNTⱼεFᵢ) (1)

The method disclosed hereby guarantees that regardless of how long a product description is the feature score depends on its most important “buzz-word”. When intended for advertisement, the features are presented in a descending order of the scores determined according to formula (1).

The present invention discloses a Closed Loop Advertisement Process based on extraction one or more important features from the information, which the vendor may insert during the inventory provisioning. This approach is illustrated by the work flow shown in the FIG. 5.

When a vendor posted a store inventory (step 500 in the FIG. 5) the system extracts the evocative features praised locally and maps them to products and locality (step 502). Those “buzz-word” characteristics become a factor of prioritizing their appearance in the advertisement process. As exemplary they may be presented prioritized according to feature score (step 504). A feedback statistics on user preference upon the evocative features is delivered to participating vendors on the step labeled 506.

The present invention purposely utilizes and uses the advertising service tied to local vendors and consumers. Therefore, a problem of balancing the system load may be naturally resolved by a implementing a distributed embodiment. That determines how the database and server may be broken down into partitions positioned near the communities participating in disclosed service. Specifically, the invention proposes allocating the vendor's inventory in a database partition closest to store location and execute a price list query on the server partition closest to a geo position of the searcher.

A preferred embodiment resolves drawbacks and disadvantages of the prior art listed above. The food vendors are motivated to subscribe for the described service, which is properly suited for an easy method of timing and convenient inventory update. The consumers are motivated to shop around using the proposed embodiment because it provides them with a uniformed and competitive price listing for stores at the nearby location. The present invention facilitates the vendors' ties to local customers and uniformly accommodates the needs of the competitive regional market, as well as the territorial or ethnic community.

What we claim is:

1. A method of developing the food market advertisement in a geo-spatial environment by the Web server with database, search engine, and interfaces to geo-position, and food categories standard, capable of communicating with the user over a stationary computer or wireless mobile device, comprising the steps of
(a) initiation a unique address name for the global Internet-based service that aggregates the vendors' inventory, bound to store location;
(b) motivating the vendors to subscribe for the said service as the most lucrative and convenient in a timely fashion via instantaneous updates by, but not limited to, mobile communication devices;
(c) attracting the consumers who desire to search bargains from plural vendors in the vicinity and do so via a comparative presentation;
(d) accomplishing the search, described in step (c), by aggregating the participant store inventory on a uniformed list upon a geographic proximity, determined from a distance range and position of the searcher;
(e) extraction the local food preferences from an individual vendor's input;
(f) utilization the said on step (e) preferences for enhancing the arbitrary regional product market advertisement.

2. A method further comprising claim 1 step (e) by:
(a) receiving distinctive food characteristics from a vendor in the form of the segmented text sequence;
(b) enforcing by the means of software for a vendor to insert the correct wording, adherent to spelling standard pertaining to a local language;
(c) analyzing the input segments from step (a) and assigning them into two classes: “Plain” description and “Evocative” features;
(d) the first class from step (c)—“Plain” further becomes the subject for literal search by a client;
(e) “Evocative” features from step (c), in addition to being used in a regular search are associated with the related products, categories, geo position of the store, and hereby utilize a features mapping for the advertisement purposes.

3. A computer program embedded on a tangible hardware readable medium to perform instructions for implementing the claim 2 step (c) wherein comprising:
(a) analysis of each word in the product description input segment to match a criterion of adjective, adverb or similar descriptive words within a local language;
(b) if the outcome to step (a) is TRUE, then it denotes that word and embracing it feature as evocative; otherwise, it treats it as a plain description.

4. A computer program embedded on a tangible hardware readable medium to perform instructions for implementing claim 1 step (f) to prioritize the features pertaining to a product, for advertisement purpose in regional food market wherein including the steps:
(a) compose a list of features pertaining to product;
(b) split the text of each feature into word segments;
(c) qualify each segment from the step (b) on criterion “Is Evocative” according to claim 3;
(d) if the word is evocative according to claim 3, then refer it in a further computation by a generic form in a local language, ignoring, but not limiting to, plurality and tense;
(e) count all features having the same evocative word from the step (d) and assign the resulting number to a score of that evocative word;
(f) define a product description of the evocative feature score equal to a score of the evocative word belonging to a said feature and having the maximum score in plurality of others within the feature;
(g) utilize the evocative features for advertisement in the arbitrary regional food market, prioritizing them according to their score from step (f) in descending order.

5. Method according to claim 2 step (e) herein to guarantees consistence of the feature extraction routine for any ethnic, territorial community,
(a) the categories are specified uniformly as a hierarchical tree structure, parsed from an internationally acclaimed food classification standard;
(b) pursuant to a hierarchal structure of the step (a), the vendor provisions the means of assigning each food product to a category, wherein each product will be attached to a branch of the hierarchical tree from the step (a).

6. The method of balancing the load of the system, implementing the method according to claim 1, which accommodates a prospective network load increase
(a) the server and database of the preferred embodiment are implemented distributed with the plural partitions situated close to areas of the most developing and expanding communities participating in the said service;
(b) the vendor's inventory is allocated in database partition according to step (a) closest to store location;
(c) execution of a price list query is placed on a server partition at nearest distance to a geo-position specified by the searcher, initiated the query.
